(19) United States
(12) Patent Application Publication
(10) Pub. No.: US 2004/0000447 A1
(43) Pub. Date: Jan. 1, 2004

(54) Connection of sound bowl of loudspeaker

(76) Inventor: A Wen Yu, Taipei (TW)

Correspondence Address: A Wen Yu, 235 Chung-Ho, Box 8-24, Taipei, TW

(21) Appl. No.: 10/179,260

(22) Filed: Jun. 26, 2002

(51) Int. Cl. H04R 7/00; G10K 13/00

(52) U.S. Cl. 181/172; 181/171

(57) ABSTRACT

A connection of the sound bowl and connecting portion of a loudspeaker is disclosed. The connection area is adhered with the elastic materials similar to the materials of sound bowl and connecting portion in order to beautify the appearance of loudspeaker and enhance the adhesion. Thereby the tolerance of the loudspeaker is enhanced. Thus, the loudspeaker is tolerable to vibration and produces sound with precise tunes, and stabilizes the quality of sound.

### BACKGROUND OF THE INVENTION

1. Field of the Invention

The present invention relates to loudspeakers, and particularly to a sound bowl structure of a loudspeaker, wherein a sound bowl is connected to a connecting portion of loudspeaker, thereby, simplifying the manufacturing process procedure and enhancing the sound effect of loudspeaker.

2. Description of the Prior Art

Generally, a loudspeaker consists of a pressing bar 3, a connecting portion 2, a sound bowl 1, a sound coil, a suspension system, and a magnet. As required, most of the loudspeakers are manufactured in such a manner that the sound bowl 1 is adhered to the surface of connecting portion 2 as shown by FIG. 1.

How the loudspeaker emits sound will be described herein. At first, electric signals is sent into a sound coil to create a magnetic field. The magnetic field of the magnet can be absorbed through vibration. Then the vibration applies presses to the sound bowl 1 and transmits expected voices through air. The vibration created by the sound bowl 1 produces voice. The sound bowl 1 also handles the volume and tunes. Therefore, the structure connecting the sound bowl 1 and connecting portion 2 determines the quality of sound and affects the life of the loudspeaker.

As shown in FIG. 1, the sound bowl 1 of the conventional loudspeaker is adhered to the connecting portion 2 by using glue. Hence, the manufacturing cost is high. The adhesion layer is possibly uneven and inaccurate. These problems affect the quality of sound and possibly damage the loudspeaker.

### SUMMARY OF THE INVENTION

The present invention relates to the connection of the sound bowl and connecting portion of a loudspeaker. The connection area is adhered with the elastic materials similar to the materials of sound bowl and connecting portion in order to beautify the appearance of loudspeaker and enhance the adhesion. Thereby the tolerance of the loudspeaker is enhanced. Thus, the loudspeaker is tolerable to vibration and produces sound with precise tunes, and stabilizes the quality of sound.

### BRIEF DESCRIPTION OF THE DRAWINGS

FIG. 1 is a sectional view showing the structure of a conventional loudspeaker;

FIG. 2 is a schematic view showing the structure of the loudspeaker of the present invention;

FIG. 3 is a structural view showing a portion of the loudspeaker of the present invention;

FIG. 4 is a schematic view showing the loudspeaker in one embodiment of present invention;

FIG. 5 is another schematic view showing the loudspeaker in one embodiment of present invention;

FIG. 6 is another schematic view showing the loudspeaker in one embodiment of present invention;

FIG. 7 is another schematic view showing the loudspeaker in one embodiment of present invention;

FIG. 8 is another structural view showing the loudspeaker in one embodiment of present invention;

FIG. 9 is a structural view showing a portion of the loudspeaker in one embodiment of present invention;

FIG. 10 is a structural view showing a portion of the loudspeaker in one embodiment of present invention; and

FIG. 11 is a structural view showing a portion of the loudspeaker in one embodiment of present invention.

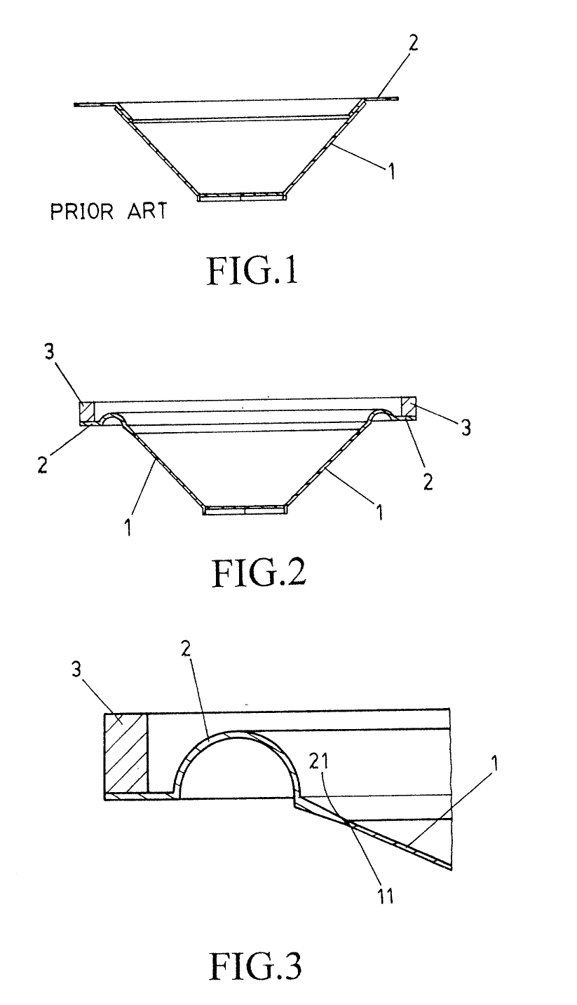

### DETAILED DESCRIPTION OF THE PREFERRED EMBODIMENT

As shown in FIG. 2, the present invention mainly comprises a sound bowl 1, a connecting portion 2, and a pressing bar 3.

The sound bowl 1 is a bowl-shaped device with a flat connection rim 11 connecting to the connecting portion 2. The connecting portion 2 is a slightly arc-shaped elastic structure serving as a buffer. The inner rim thereof is also a flat connection rim 21 as shown by FIG. 3.

The sound bowl 1 and connecting portion 2 can be made of hard plastic materials, such as PP and PS. Both flat connection rims 11, 21 are connected with thermal-plastic elastomers and are kept at a temperature of about 100˜140° C.; and thermal-plastic material are injected into a mold to connect both flat connection rims 11, 21 under proper temperatures (such as 160˜210° C.) as one piece.

The foregoing manufacturing process ensures the firm connection between the sound bowl 1 and connecting portion 2, and is capable of tolerating the effects of different levels of volumes and tunes, thereby making the sound perfect and attractive.

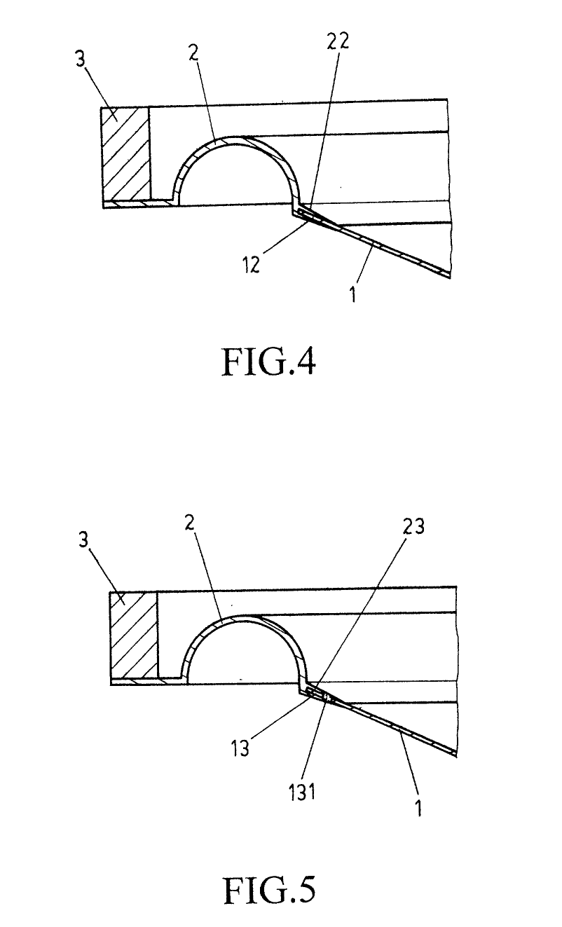

As shown by FIG. 4, the manufacturers can also use the plug-in connection ends 12, 22 to connect the sound bowl 1 and connecting portion 2; thereby enlarging the contact area and enhances the reliability of connection by the double-sided wrapping structure.

As shown by FIG. 5, in another embodiment of the present invention, punching-holed connection ends 13, 23 are used for the connection in the present invention. The design of present invention allows the thermal-plastic elastomers to be filled into the punching hole 131. Thereby enhancing the connection.

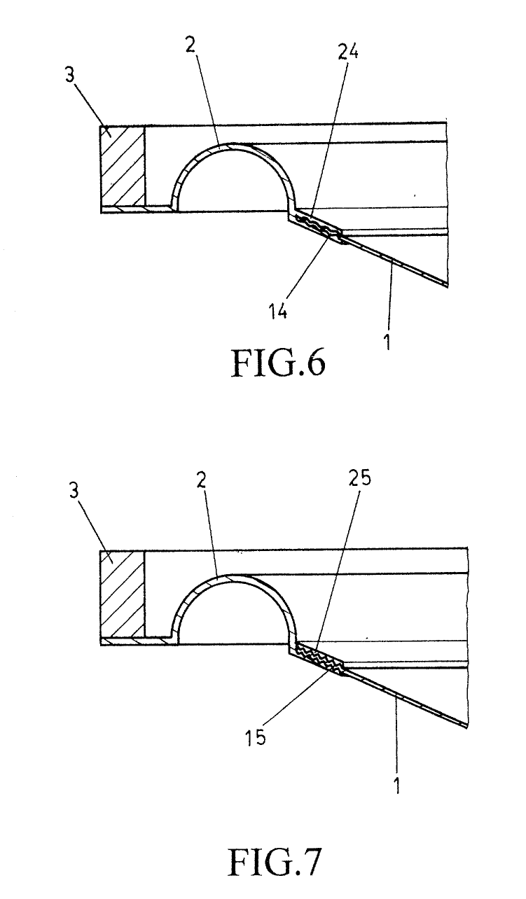

As shown by FIG. 6 and FIG. 7, in a further embodiment, the connection of present invention can be made by the arc connection ends 14, 24 or the right-angled connection ends 15, 25.

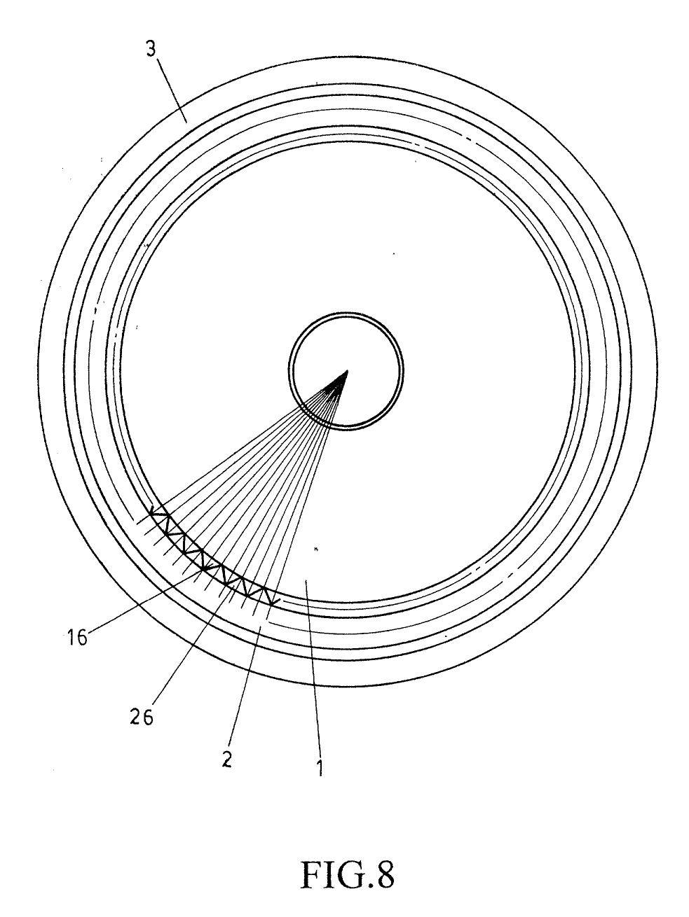

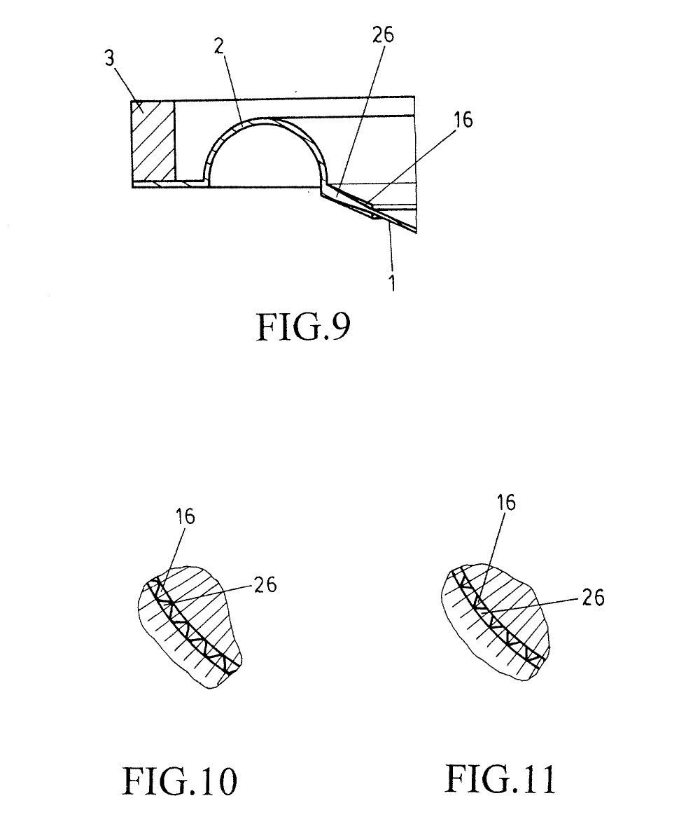

The connection surface of the trumpet of present invention can be folded shown in FIG. 8 and FIG. 9. The folded structure or circumferences 16, 26 can be either sharp angles or the shape shown in FIG. 10. The round-angled structure and flat-angled structure stated in FIG. 11 can enhance the tolerance of connection.

By the above state structure, the present invention is capable of upgrading the performance of loudspeaker and improving the quality of sound in order to solve the problems of the conventional loudspeaker.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

1. A loudspeaker comprising a bowl-shaped sound bowl and an arc-shaped elastic connecting portion; characterized in that: the connecting sides of the sound bowl and the connecting portion are connected by thermal-plastic elastomers; in manufacturing, thermal-plastic elastomer is injected into a mold to connect the connecting portion and the sound bowl at a predetermined temperature.

2. The loudspeaker as claimed in claim 1, wherein the sound bowl and connecting portion are made of hard plastic materials.

3. The loudspeaker as claimed in claim 2, wherein the plastic material is selected from one of a group containing PP and PS.

4. The loudspeaker as claimed in claim 1, wherein connecting sides of the sound bowl and the connecting portion are connected by thermal-plastic elastomer.

5. The loudspeaker as claimed in claim 1, wherein the connecting sides of the sound bowl and connecting portion are flat.

6. The loudspeaker as claimed in claim 1, wherein the connecting side of the sound bowl is engaged with the connecting side of the connecting portion.

7. The loudspeaker as claimed in claim 1, wherein the connecting sides of the sound bowl and the connection portion are punched with holes; and the thermal plastic material is filled into the holes.

8. A modified structure for loudspeaker as stated in claim 1, the connecting sides of the sound bowl and the connecting portion are folded as a plurality of folds along the peripherys of the edges of the sound bowl ad the connecting portion.
